(19) United States
(12) Patent Application Publication
(10) Pub. No.: US 2026/0056304 A1
(43) Pub. Date: Feb. 26, 2026

(54) LIDAR SENSORS WITH NANOPHOTONIC POLARIZATION ROUTERS

(71) Applicant: SEMICONDUCTOR COMPONENTS INDUSTRIES, LLC, Scottsdale, AZ (US)

(72) Inventor: Swarnal BORTHAKUR, Boise, ID (US)

(73) Assignee: SEMICONDUCTOR COMPONENTS INDUSTRIES, LLC, Scottsdale, AZ (US)

(21) Appl. No.: 18/813,781

(22) Filed: Aug. 23, 2024

(51) Int. Cl. G01S 7/499; G01S 7/48; G01S 17/32; G01S 17/86; G01S 17/931

(52) U.S. Cl. CPC G01S 7/499; G01S 17/32; G01S 17/86; G01S 17/931; G01S 7/4808

(57) ABSTRACT

Light detection and ranging (LIDAR) sensors, LIDAR systems, and methods for performing LIDAR. The LIDAR sensing includes a pixel array and a spectral router. The pixel array includes first, second, third, and fourth pixels arranged in a two-by-two grid. The spectral router is configured to route a first light with a first polarization to the first pixel. The spectral router is also configured to route a second light with a second polarization to the second pixel. The second polarization is about forty-five degrees greater than the first polarization. The spectral router is further configured to route a third light with a third polarization to the third pixel. The third polarization is orthogonal to the second polarization. The spectral router is also configured to route a fourth light with a fourth polarization to the fourth pixel. The fourth polarization is orthogonal to the first polarization.

### BACKGROUND

Light detection and ranging (LIDAR) is used in many industrial applications such as logistics, factory automation, medical, health, and agriculture. LIDAR is also used in many consumer applications such as augmented reality, virtual reality, gaming, and object scanning. LIDAR is also used in many automotive applications such as in-cabin monitoring and advanced driver assistance systems. LIDAR systems may determine the distance and speed of objects using time-of-flight (ToF) techniques. For example, indirect ToF measures distance by collecting reflected light and discerning the phase shift between emitted and reflected light. Further, direct ToF measures distance based on the amount of time until reflection is detected.

### SUMMARY

In addition to determining the distance and speed of an object, it is desirable to distinguish between different types of objects. For example, an autonomous vehicle driving system may react differently in response to detecting a human in the road ahead as opposed to detecting another vehicle. However, ToF does not distinguish between different types of objects. The present disclosure provides LIDAR sensors, LIDAR systems, and methods that, among other things, use polarized light for object type detection.

The present disclosure provides a light detection and ranging (LIDAR) sensor. The LIDAR sensing includes, in one implementation, a pixel array and a spectral router. The pixel array includes a first pixel, a second pixel, a third pixel, and a fourth pixel arranged in a two-by-two grid. The spectral router is configured to route a first light with a first polarization to the first pixel. The spectral router is also configured to route a second light with a second polarization to the second pixel. The second polarization is about forty-five degrees greater than the first polarization. The spectral router is further configured to route a third light with a third polarization to the third pixel. The third polarization is orthogonal to the second polarization. The spectral router is also configured to route a fourth light with a fourth polarization to the fourth pixel. The fourth polarization is orthogonal to the first polarization.

The present disclosure also provides a LIDAR system including, in one implementation, a LIDAR source, a LIDAR sensor, and a LIDAR controller. The LIDAR source is configured to illuminate an object with a first interrogating light having a first polarization. The LIDAR source is also configured to illuminate the object with a second interrogating light having a second polarization. The LIDAR source is further configured to illuminate the object with a third interrogating light having a third polarization that is orthogonal to the second polarization. The LIDAR source is also configured to illuminate the object with a fourth interrogating light having a fourth polarization that is orthogonal to the first polarization. The LIDAR sensor includes a pixel array including a plurality of pixel subsets. Each of the plurality of pixel subsets includes four pixels and a spectral router. The four pixels are configured to generate pixel signals. The spectral router is configured to route a first reflected light having the first polarization to a first of the four pixels. The spectral router is also configured to route a second reflected light having the second polarization to a second of the four pixels. The spectral router is further configured to route a third reflected light having the third polarization to a third of the four pixels. The spectral router is also configured to route a fourth reflected light having the fourth polarization to a fourth of the four pixels. The LIDAR controller is configured to determine whether the object is metal based on the pixel signals.

The present disclosure further provides a method for performing LIDAR. The method includes illuminating an object with interrogating light having a first polarization, a second polarization that is about forty-five degrees greater than the first polarization, a third polarization that is orthogonal to the second polarization, and a fourth polarization that is orthogonal to the first polarization. The method also includes routing, with a spectral router, a first reflected light having the first polarization to a first set of pixels included in a pixel array. The method further includes routing, with the spectral router, a second reflected light having the second polarization to a second set of pixels included in the pixel array. The method also includes routing, with the spectral router, a third reflected light having the third polarization to a third set of pixels included in the pixel array. The method further includes routing, with the spectral router, a fourth reflected light having the fourth polarization to a fourth set of pixels included in the pixel array. The method also includes generating a plurality of pixel signals with the pixel array. The method further includes determining whether the object is metal based on the plurality of pixel signals.

### BRIEF DESCRIPTION OF THE DRAWINGS

For a detailed description of example implementations, reference will now be made to the accompanying drawings in which:

FIG. 1 is a block diagram of an example of a LIDAR system in accordance with some implementations;

FIG. 2 is a diagram of an example of a LIDAR system incorporated in a vehicle in accordance with some implementations;

FIG. 3 is a partial schematic and a partial block diagram of an example of a LIDAR sensor in accordance with some implementations;

FIG. 4 is a schematic of an example of circuitry in a pixel in accordance with some implementations;

FIG. 5A is a diagram of an example of light reflecting off of a metal object, in accordance with some implementations;

FIG. 5B is a diagram of an example of light reflecting off of a non-metal object, in accordance with some implementations;

FIG. 6A is a view of an example of a two-by-two pixel subset of NIR pixels in accordance with some implementations;

FIG. 6B is a cross-sectional view of the two-by-two pixel subset of FIG. 6A in accordance with some implementations;

FIG. 6C is a cross-sectional view of the two-by-two pixel subset of FIG. 6B with an infrared spectral filter in accordance with some implementations;

FIG. 7 is a flow diagram of an example of a method for performing LIDAR in accordance with some implementations.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. To be clear, an initial reference to “a [referent]”, and then a later reference for antecedent basis purposes to “the [referent]”, shall not obviate that the recited referent may be plural.

Terms defining an elevation, such as “above,” “below,” “upper”, and “lower” shall be locational terms in reference to a direction of light incident upon a pixel array and/or an image pixel. Light entering shall be considered to interact with or pass objects and/or structures that are “above” and “upper” before interacting with or passing objects and/or structures that are “below” or “lower.” Thus, the locational terms may not have any relationship to the direction of the force of gravity.

“About” in reference to a recited parameter shall mean the recited parameter plus or minus ten percent (+/−10%) of the recited parameter.

“Assert” shall mean creating or maintaining a first predetermined state of a Boolean signal. Boolean signals may be asserted high or with a higher voltage, and Boolean signals may be asserted low or with a lower voltage, at the discretion of the circuit designer. Similarly, “de-assert” shall mean creating or maintaining a second predetermined state of the Boolean, opposite the asserted state.

In relation to electrical devices, whether stand alone or as part of an integrated circuit, the terms “input” and “output” refer to electrical connections to the electrical devices, and shall not be read as verbs requiring action. For example, a differential amplifier, such as an operational amplifier, may have a first differential input and a second differential input, and these “inputs” define electrical connections to the operational amplifier, and shall not be read to require inputting signals to the operational amplifier.

“Controller” shall mean, alone or in combination, individual circuit components, an application specific integrated circuit (ASIC), a microcontroller with controlling software, a reduced-instruction-set computer (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

“Visible light” shall mean light ranging between about 400 and 750 nanometers (nm). “Near infrared light” or “NIR light” shall mean light with ranging from about 750 and 1,000 nm.

### DETAILED DESCRIPTION

The following discussion is directed to various implementations of the invention. Although one or more of these implementations may be preferred, the implementations disclosed should not be interpreted, or otherwise used, as limiting the scope of the present disclosure, including the claims. In addition, one skilled in the art will understand that the following description has broad application, and the discussion of any implementation is meant only to be exemplary of that implementation, and not intended to intimate that the scope of the present disclosure, including the claims, is limited to that implementation.

Various examples are directed to light detection and ranging (LIDAR) sensors, LIDAR systems, and related methods. More particularly, at least some examples are directed to LIDAR systems designed and constructed to detect object types using polarized light. More particularly still, various examples are directed to LIDAR sensors with pixel subsets configured to detect light with four different polarizations. More particularly, various examples are directed to pixels in LIDAR sensors with spectral routers that steer near infrared (NIR) or visible light according to polarization. The specification now turns to an example system to orient the reader.

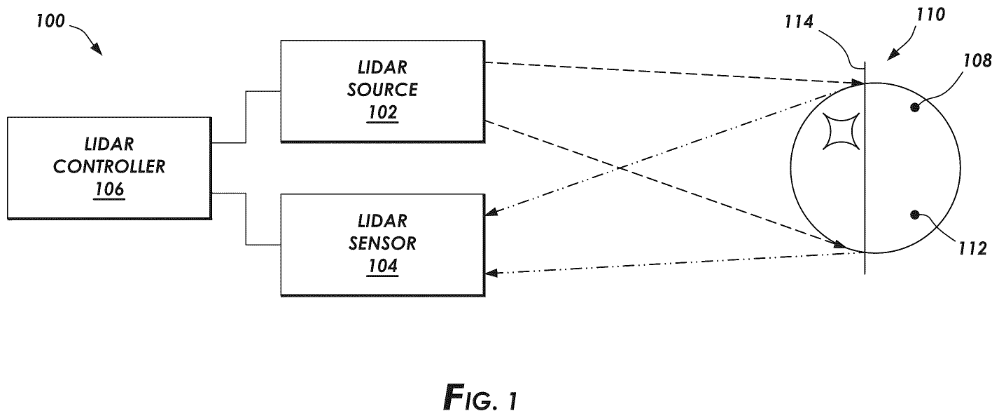

FIG. 1 shows, in block diagram form, an example of a LIDAR system 100. In particular, the LIDAR system 100 illustrated in FIG. 1 comprises a LIDAR source 102, a LIDAR sensor 104, and a LIDAR controller 106. The LIDAR source 102 is designed and constructed to direct interrogating light into a scene in front of the LIDAR source 102. The LIDAR source 102 may be any suitable source of light for use in a LIDAR system. In one example, the LIDAR source 102 may include an array of laser diodes, such as an array of vertical-cavity surface-emitting laser (VCSEL) diodes. In some implementations, the light created by the LIDAR source 102 is outside the visible spectrum, such as NIR light. Turning now to the LIDAR sensor 104.

The LIDAR sensor 104 includes a plurality of pixels. As will be discussed in greater detail below, the pixels of the LIDAR sensor 104 may be organized into rows and columns. When properly configured, each pixel is sensitive to the arrival of interrogating light that reflects from objects within the scene. Interrogating light that reflects from objects within the scene is hereafter referred to as reflected light. Turning now to the LIDAR controller 106.

The LIDAR controller 106 is coupled to the LIDAR source 102 to control the timing of generating and release of interrogating light. Moreover, the LIDAR controller 106 is coupled to the LIDAR sensor 104 such that the LIDAR controller 106 receives image data from the LIDAR sensor 104. Image data may include one or more pixel signals, one or more images, one or more histograms, or a combination thereof. Based on an analysis of the image data, the LIDAR controller 106 determines the combined time-of-flight of the outgoing interrogating light and returning reflected light.

The LIDAR source 102 illuminates the scene with interrogating light. However, for LIDAR systems, the interrogating light may not simultaneously illuminate the entire scene. Rather, in the LIDAR system 100, the LIDAR source 102 selectively illuminates the scene in particular directions, and by repetitively illuminating the scene along incrementally varying directions, ultimately the entire scene is illuminated in a piecewise fashion. The steering of the interrogating light may take any suitable form, such as a solid-state implementation of the LIDAR source 102 that steers the interrogating light by selective operation of a phased array source, or a mechanical system in which the interrogating light is steered or directed by movable lenses and/or mirrors.

In one example, the LIDAR source 102 may illuminate the scene using a series of laser “dots” launched from the LIDAR source 102. For example, the LIDAR source 102 may be designed and constructed to generate a first interrogating light in the form of a first dot 108. That is, the interrogating light is sent out in the form of a tight beam of light that intersects in example object within the scene, here with an example object shown as sphere 110. The first dot 108 of interrogating light reflects back to the LIDAR sensor 104 to be used for determining the distance to the sphere 110 at the location of the first dot 108. Second interrogating light may be sent in the form of a second dot 112, and as before the second dot 112 of interrogating light reflects back to the LIDAR sensor 104. By sequentially illuminating the scene with dots of interrogating light, the location and distance to objects within the scene, such as the sphere 110, may be determined. Illuminating the scene with dots of interrogating light may be used when the LIDAR sensor 104 is a single “row” of pixels.

In other cases, the LIDAR source 102 may illuminate the scene using lines of interrogating light. For example, the LIDAR source 102 may be designed and constructed to generate first interrogating light in the form of line 114 of light. That is, the interrogating light is sent out in the form of a line of light that intersects the sphere 110 at several locations. The line 114 of infrared is shown as a vertical line, but in other cases the line 114 may be a horizontal line, or the line 114 may sweep the sphere 110 at any suitable angle. The line 114 of interrogating light reflects back to the LIDAR sensor 104 to be used for determining distance to the object in the scene at the various locations intersected by the line 114. Thereafter, further interrogating light may be sent in the form of additional lines at locations offset from line 114. By sequentially illuminating the scene with lines of interrogating light, the location and distance to the sphere 110 may be determined. Illuminating the scene with lines of interrogating light may be used when the LIDAR sensor 104 has multiple rows of pixels.

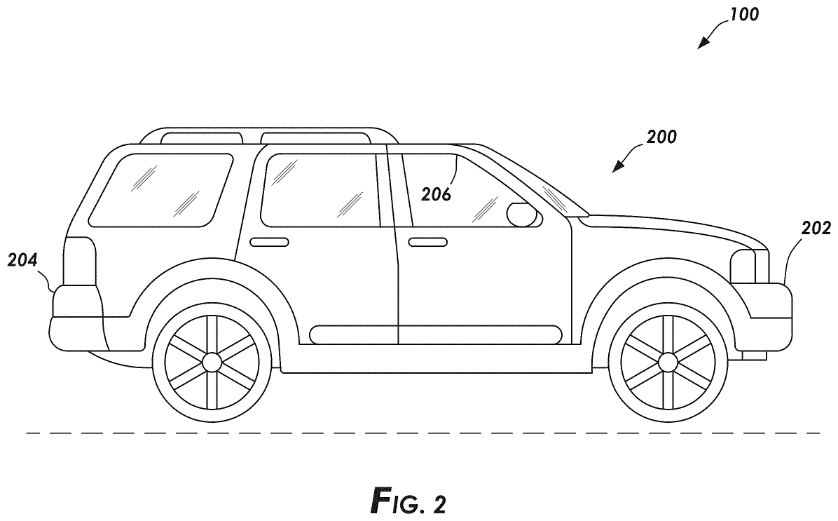

FIG. 2 shows another example of the LIDAR system 100. The LIDAR system 100 illustrated in FIG. 2 comprises an automobile or vehicle 200. The vehicle 200 is illustratively shown as a passenger vehicle, but the LIDAR system 100 may be other types of vehicles, including commercial vehicles, on-road vehicles, and off-road vehicles. Commercial vehicles may include busses and tractor-trailer vehicles. Off-road vehicles may include tractors and crop harvesting equipment. In the example of FIG. 2, the vehicle 200 includes a forward-looking LIDAR 202 arranged to capture images of scenes in front of the vehicle 200. The forward-looking LIDAR 202 can be used for any suitable purpose, such as lane-keeping assist, collision warning systems, distance-pacing cruise-control systems, autonomous driving systems, and proximity detection. The vehicle 200 further comprises a backward-looking LIDAR 204 arranged to capture images of scenes behind the vehicle 200. The backward-looking LIDAR 204 can be used for any suitable purpose, such as collision warning systems, reverse direction video, autonomous driving systems, proximity detection, monitoring position of overtaking vehicles, and backing up. The vehicle 200 further comprises a side-looking camera module 206 arranged to capture images of scenes beside the vehicle 200. The side-looking camera module 206 can be used for any suitable purpose, such as blind-spot monitoring, collision warning systems, autonomous driving systems, monitoring position of overtaking vehicles, lane-change detection, and proximity detection. In situation in which the LIDAR system 100 is a vehicle, the LIDAR controller 106 may be a controller of the vehicle 200. The discussion now turns in greater detail to the LIDAR sensor 104.

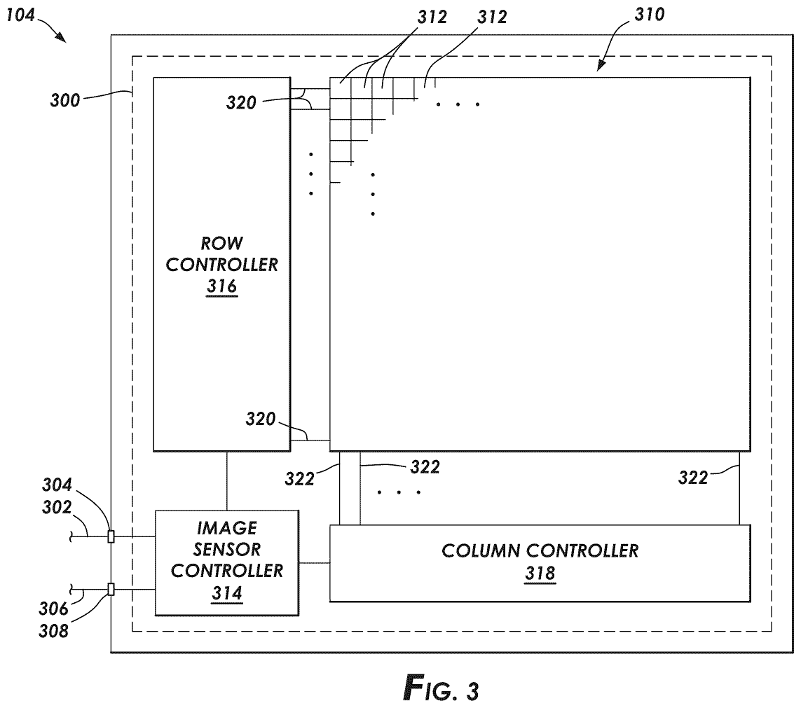

FIG. 3 shows an example of the LIDAR sensor 104. In particular, FIG. 3 shows that the LIDAR sensor 104 may comprise a substrate 300 of semiconductor material, such as silicon, encapsulated within packaging to create a packaged semiconductor device or packaged semiconductor product. Bond pads or other connection points of the substrate 300 couple to terminals of the LIDAR sensor 104. The connections may comprise a serial communication channel 302 coupled to a first terminal 304, and a capture input 306 coupled to a second terminal 308. Additional terminals will be present, such as ground, common, or power, but the additional terminals are omitted so as not to unduly complicate the figure. While a single instance of the substrate 300 is shown, in other implementations, multiple substrates may be combined to form the LIDAR sensor 104 in a multi-chip module created before or after singulation.

The LIDAR sensor 104 illustrated in FIG. 3 includes a pixel array 310 with a plurality of pixels, such as pixels 312. The pixel array 310 may include, for example, hundreds or thousands of rows and columns of pixels 312. Control and readout of the pixel array 310 may be implemented by an image sensor controller 314 coupled to a row controller 316 and a column controller 318. The row controller 316 may receive row addresses from the image sensor controller 314 and supply corresponding row control signals to pixels 312, such as reset, row select, charge transfer, and readout control signals. The row control signals may be communicated over one or more conductors, such as row control paths 320.

The column controller 318 may be coupled to the pixel array 310 by way of one or more conductors, such as column lines 322. Column controllers may sometimes be referred to as column control circuits, readout circuits, or column decoders. The column lines 322 may be used for reading out pixel signals from pixels 312 and for supplying bias currents and/or bias voltages to pixels 312. If desired, during readout operations, a pixel row in the pixel array 310 may be selected using the row controller 316 and pixels signals generated by the pixels 312 in that pixel row can be read out along the column lines 322. The column controller 318 may include sample-and-hold circuitry for sampling and temporarily storing signals read out from the pixel array 310, amplifier circuitry, analog-to-digital conversion (ADC) circuitry, bias circuitry, column memory, latch circuitry for selectively enabling or disabling the column circuitry, or other circuitry that is coupled to one or more columns of pixels 312 in the pixel array 310 for operating the pixels 312 and for reading out pixel signals from the pixel array 310. ADC circuitry in the column controller 318 may convert analog pixel values received from the pixel array 310 into corresponding digital data. The column controller 318 may supply the digital data to the image sensor controller 314 and/or the LIDAR controller 106 of FIG. 1 over, for example, the serial communication channel 302.

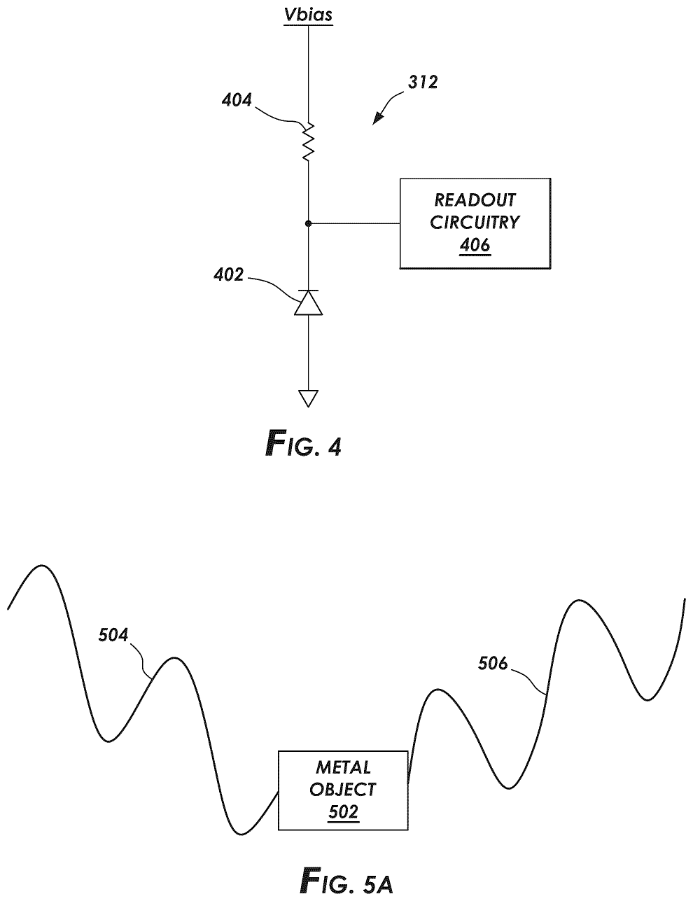

FIG. 4 is an electrical schematic of an example of one of the pixels 312 in the pixel array 310. The pixel 312 illustrated in FIG. 4 includes a single-photon avalanche diode (SPAD 402) and a quenching resistor 404. In some implementations, some or all of the pixels 312 in the pixel array 310 may have the same components in the same configuration as the pixel 312 illustrated in FIG. 4. In other implementations, some or all of the pixels 312 in the pixel array 310 may have fewer components, additional components, or different components in different configurations than the pixel 312 illustrated in FIG. 4. For example, each of the pixels 312 may include a plurality of SPADs.

The SPAD 402 is an example of a photodetector. The SPAD 402 defines an anode coupled to ground or common, and a cathode coupled to the quenching resistor 404. The quenching resistor 404 couples the SPAD 402 to a positive power supply voltage, such as bias voltage Vbias. The bias voltage Vbias is higher than the breakdown voltage of the SPAD 402. Thus, absorption of a single photon by the SPAD 402 can cause a large avalanche current in the SPAD 402 due to impact ionization. While the avalanche current continues, subsequent photons incident on the SPAD 402 cannot be detected. To enable detection of subsequent photons incident on the SPAD 402, the quenching resistor 404 stops the avalanche process by lowering the bias voltage of the SPAD 402 below the breakdown level. The SPAD 402 is quenched and reset for every initiated avalanche current. During the time required to quench and reset the SPAD 402, referred to as the dead time, no additional photons can be detected by the SPAD 402. The dead time therefore limits the number of photons detectable by the SPAD 402 for a given time period. In some implementations, the dead time of the SPAD 402 may be on the order of nanoseconds, for example about three nanoseconds.

The avalanche current produces an electrical signal that can be detected by a readout circuitry 406. For example, initiation of the avalanche current due to detection of an incident photon by the microcell and subsequent quenching of the avalanche current may create a pulse current signal that the readout circuitry 406 can identify as a photon detection. The pulse current signal may be referred to herein as an avalanche pulse. The readout circuitry 406 may process the detection of the current signal for a variety of purposes, for example counting the number of incident photons by counting the number of avalanche current pulses using analog or digital pulse counting circuits, and timing the laser time-of-flight (ToF) for determining a distance to the target. In FIG. 4, the readout circuitry 406 is coupled to the node between the SPAD 402 and the quenching resistor 404. In some implementations, the readout circuitry 406 may be coupled to the node between the quenching resistor 404 and the positive power supply voltage. In some implementations, the quenching resistor 404 may be integrated with the readout circuitry 406. In some implementations, the readout circuitry 406 may be integrated with the column controller 318.

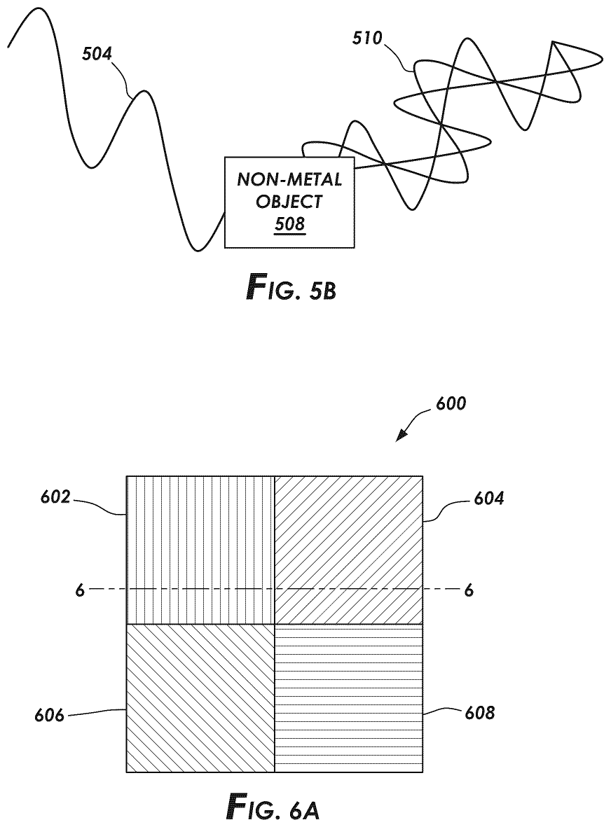

Metal objects reflect polarized light like mirrors. For example, in FIG. 5A, a metal object 502 is illuminated with polarized light 504, resulting in a reflected light 506 that has the same polarization as the polarized light 504. On the other hand, non-metal objects modify (or disturb) polarized light. For example, in FIG. 5B, a non-metal object 508 is illuminated with the polarized light 504, resulting in a reflected light 510 that non-polarized. As described in more detail below, the LIDAR system 100 uses polarized light to determine the type of objects in a scene.

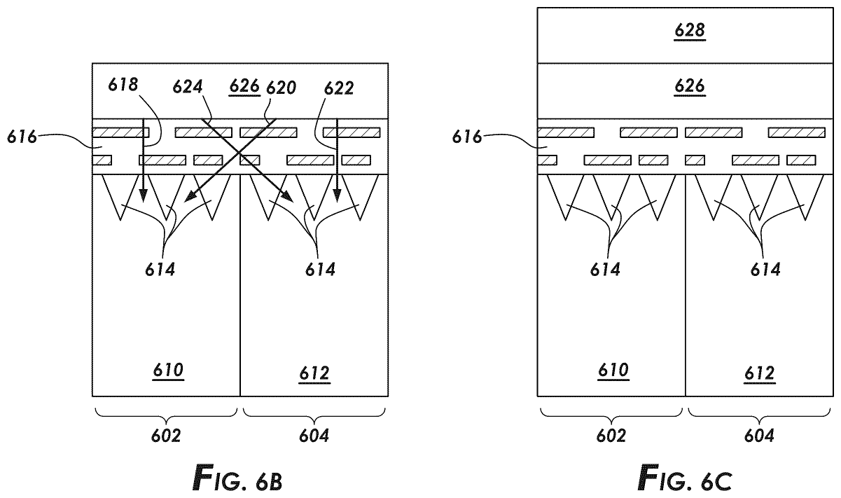

FIG. 6A shows a view of a two-by-two pixel subset 600 included in the pixel array 310. The pixel array 310 may include a plurality of the two-by-two pixel subsets 600 positioned throughout the pixel array 310. The two-by-two pixel subset 600 illustrated in FIG. 6A includes a first pixel 602 for detecting 90° polarized NIR light, a second pixel 604 for detecting 45° polarized NIR light, a third pixel 606 for detecting 135° polarized NIR light, and a fourth pixel 608 for detecting 0° polarized NIR light. In some implementations, the first pixel 602, the second pixel 604, the third pixel 606, and the fourth pixel 608 are each configured to detect different polarizations of light than the ones indicated above.

FIG. 6B shows a cross-sectional view of the two-by-two pixel subset 600 taken at line 6-6 of FIG. 6A. In particular, FIG. 6B shows that the first pixel 602 includes a first photodetector 610 and the second pixel 604 includes a second photodetector 612. The first photodetector 610 and the second photodetector 612 include a plurality of pyramid trenches 614 configured to disperse NIR light evenly across the first photodetector 610 and the second photodetector 612. The plurality of pyramid trenches 614 are one example of a light scattering structure that may be included in the first photodetector 610 and the second photodetector 612. In some implementations, the first photodetector 610 and the second photodetector 612 may include other light scattering structures such as vertical trenches. In the example shown, the first photodetector 610 and the second photodetector 612 abut each other, but in other cases one or more additional layers, such as oxide layers or deep trench isolation (DTI) structures, may reside between them.

Polarizers pass polarized light which have the same polarization (or direction). For example, a polarizer with a 45° polarization passes polarized light with a 45° polarization. Polarizers also block polarized light which have an orthogonal polarization. For example, a polarizer with a 45° polarization blocks polarized light with a 135° polarization. Polarizers further pass non-polarized light with diminished intensity. A spectral router (or nanophotonic light guide) is an optical structure that accepts photons incident on an upper surface. The spectral router then diverts photons from the upper surface to the underlying photosensitive regions of photodiodes. As described in more detail below, a spectral router can be configured to operate as a polarizer.

FIG. 6B shows that a spectral router 616 is positioned above the first photodetector 610 and the second photodetector 612. In the example shown in FIG. 6B, the spectral router 616 abuts the first photodetector 610 and the second photodetector 612, but in other cases one or more additional layers, such as oxide or planar layers, may reside between them. Although not visible in the cross-sectional view of FIG. 6B, the spectral router 616 is also positioned above photodetectors of the third pixel 606 and the fourth pixel 608. As described in more detail below, the spectral router 616 is configured to direct light to the first pixel 602, the second pixel 604, the third pixel 606, or the fourth pixel 608 based on the polarization of the light.

The spectral router 616 is configured to direct 90° polarized NIR light to the first photodetector 610. For example, the portion of the spectral router 616 positioned above the first photodetector 610 is configured to pass 90° polarized NIR light to the first photodetector 610. Consider, for purposes of discussion, 90° polarized NIR light entering the spectral router 616 above the first photodetector 610. An example of such 90° polarized NIR light is illustrated in FIG. 6B by arrow 618. The 90° polarized NIR light initially encounters a portion of the spectral router 616 positioned above the first photodetector 610, which passes the 90° polarized NIR light to the first photodetector 610. Further, the portion of the spectral router 616 positioned above the second photodetector 612 is configured to direct 90° polarized NIR light to the first photodetector 610. Consider, for purposes of discussion, 90° polarized NIR light entering the spectral router 616 above the second photodetector 612. An example of such 90° polarized NIR light is illustrated in FIG. 6B by arrow 620. The 90° polarized NIR light initially encounters a portion of the spectral router 616 positioned above the second photodetector 612, which directs the 90° polarized NIR light to the first photodetector 610.

The spectral router 616 is also configured to direct 45° polarized NIR light to the second photodetector 612. For example, the portion of the spectral router 616 positioned above the second photodetector 612 is configured to pass 45° polarized NIR light to the second photodetector 612. Consider, for purposes of discussion, 45° polarized NIR light entering the spectral router 616 above the second photodetector 612. An example of such 45° polarized NIR light is illustrated in FIG. 6B by arrow 622. The 45° polarized NIR light initially encounters a portion of the spectral router 616 positioned above the second photodetector 612, which passes the 45° polarized NIR light to the second photodetector 612. Further, the portion of the spectral router 616 positioned above the first photodetector 610 is configured to direct 45° polarized NIR light to the second photodetector 612. Consider, for purposes of discussion, 45° polarized NIR light entering the spectral router 616 above the first NIR photodetector 610. An example of such 45° polarized NIR light is illustrated in FIG. 6B by arrow 624. The 45° polarized NIR light initially encounters a portion of the spectral router 616 positioned above the first photodetector 610, which directs the 45° polarized NIR light to the second photodetector 612.

As described above, although not visible in the cross-sectional view of FIG. 6B, the spectral router 616 is also positioned above the photodetectors of the third pixel 606 and the fourth pixel 608. The spectral router 616 is configured to direct 135° polarized NIR light to the photodetector of the third pixel 606, and direct 0° polarized NIR light to the photodetector of the fourth pixel 608. FIG. 6B also shows that a band-pass light filter 626 is positioned over the spectral router 616. The band-pass light filter 626 is configured to pass NIR light with a predetermined wavelength to the spectral router 616 and block (or absorb) light with other wavelengths from entering the spectral router 616. As a first example, the band-pass light filter 626 may pass 850 nanometer light to the spectral router 616 and block all other light from entering the spectral router 616. As a second example, the band-pass light filter 626 may pass 940 nanometer light to the spectral router 616 and block all other light from entering the spectral router 616. The band-pass light filter 626 may include one or more interference filters, one or more color filters, or a combination thereof. In some implementations, an infrared spectral filter 628 is positioned over the band-pass light filter 626, as illustrated in FIG. 6C. The infrared spectral filter 628 is configured to pass NIR light and block (or absorb) visible light.

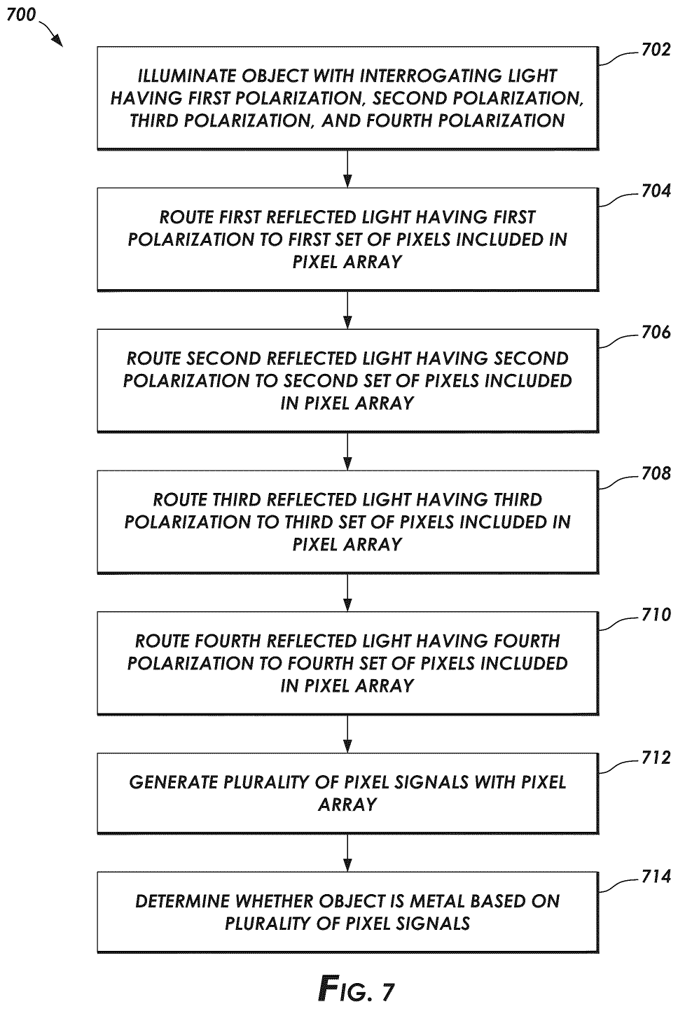

FIG. 7 is a flow diagram of an example of a method 700 for performing LIDAR with polarized light in accordance with some implementations. For simplicity of explanation, the method 700 is depicted in FIG. 7 and described as a series of operation. However, the operations can occur in various orders and/or concurrently, and/or with other operations not presented and described herein. At block 702, an object is illuminated with interrogating light having a first polarization, a second polarization, a third polarization, and a fourth polarization. The second polarization is about forty-five degrees greater than the first polarization. For example, the second polarization may be 90° when the first polarization is 45°. The third polarization is orthogonal to the second polarization. For example, the third polarization may be 0° when the second polarization is 90°. The fourth polarization is orthogonal to the first polarization. For example, the fourth polarization may be 135° when the first polarization is 45°. In some implementations, the LIDAR source 102 may continuously emit a sequence of interrogating light having the first polarization, then the second polarization, then the third polarization, and then the fourth polarization. For example, the LIDAR source 102 may continuously emit a sequence of 90° polarized NIR light, then 45° polarized NIR light, 135° then polarized NIR light, and then 0° polarized NIR light.

At block 704, a first reflected light having the first polarization is routed to a first set of pixels included in the pixel array. The first reflected light may include, for example, 90° polarized NIR light that reflects off of a metal object in response to the LIDAR source 102 illuminating the metal object with 90° polarized NIR light. The first reflected light may also include a portion of non-polarized NIR light that reflects off of a non-metal object in response to the LIDAR source 102 illuminating the non-metal object with 90° polarized NIR light. The first set of pixels may include the first pixel 602 in each two-by-two pixel subset 600 of the pixel array 310. For example, the spectral router 616 in each two-by-two pixel subset 600 of the pixel array 310 may route the first reflected light to the corresponding first pixel 602 in each two-by-two pixel subset 600 of the pixel array 310.

At block 706, a second reflected light having the second polarization is routed to a second set of pixels included in the pixel array. The second reflected light may include, for example, 45° polarized NIR light that reflects off of a metal object in response to the LIDAR source 102 illuminating the metal object with 45° polarized NIR light. The first reflected light may also include a portion of non-polarized NIR light that reflects off of a non-metal object in response to the LIDAR source 102 illuminating the non-metal object with 45° polarized NIR light. The second set of pixels may include the second pixel 604 in each two-by-two pixel subset 600 of the pixel array 310. For example, the spectral router 616 in each two-by-two pixel subset 600 of the pixel array 310 may route the second reflected light to the corresponding second pixel 604 in each two-by-two pixel subset 600 of the pixel array 310.

At block 708, a third reflected light having the third polarization is routed to a third set of pixels included in the pixel array. The third reflected light may include, for example, 135° polarized NIR light that reflects off of a metal object in response to the LIDAR source 102 illuminating the metal object with 135° polarized NIR light. The third reflected light may also include a portion of non-polarized NIR light that reflects off of a non-metal object in response to the LIDAR source 102 illuminating the non-metal object with 135° polarized NIR light. The third set of pixels may include the third pixel 606 in each two-by-two pixel subset 600 of the pixel array 310. For example, the spectral router 616 in each two-by-two pixel subset 600 of the pixel array 310 may route 135° polarized NIR light to the corresponding third pixel 606 in each two-by-two pixel subset 600 of the pixel array 310.

At block 710, a fourth reflected light having the fourth polarization is routed to a fourth set of pixels included in the pixel array. The fourth reflected light may include, for example, 0° polarized NIR light that reflects off of a metal object in response to the LIDAR source 102 illuminating the metal object with 0° polarized NIR light. The fourth reflected light may also include a portion of non-polarized NIR light that reflects off of a non-metal object in response to the LIDAR source 102 illuminating the non-metal object with 0° polarized NIR light. The fourth set of pixels may include the fourth pixel 608 in each two-by-two pixel subset 600 of the pixel array 310. For example, the spectral router 616 in each two-by-two pixel subset 600 of the pixel array 310 may route 0° polarized NIR light to the corresponding fourth pixel 608 in each two-by-two pixel subset 600 of the pixel array 310.

At block 712, the pixel array generates a plurality of pixel signals. For example, the first pixel 602 may output a pixel signal representative of the magnitude of charge generated by the first photodetector 610 during an integration time. Further, the second pixel 604 may output a pixel signal representative of the magnitude of charge generated by the second photodetector 612 during an integration time.

At block 714, the LIDAR controller 106 determines whether the object is metal based on the plurality of pixel signals. As a first example, when the LIDAR source 102 illuminates a metal object with 90° polarized NIR light, the spectral router 616 directs the reflected 90° polarized NIR light to the first pixel 602 and blocks the fourth pixel 608 from receiving the reflected 90° polarized NIR light. Thus, the LIDAR controller 106 may determine that the object is metal when the first pixel 602 detects light and the fourth pixel 608 detects no (or very little) light. As a second example, when the LIDAR source 102 illuminates a non-metal object with 90° polarized NIR light, the spectral router 616 may pass portions of the reflected non-polarized NIR light to the first pixel 602, the second pixel 604, the third pixel 606, the fourth pixels 608, or a combination thereof. Thus, the LIDAR controller 106 may determine that the object is non-metal when the first pixel 602, the second pixel 604, the third pixel 606, the fourth pixel 608, or a combination thereof each detect small intensities of light. In some implementations, the LIDAR controller 106 may include an artificial intelligence (AI) processor with a Deep Neural Network (DNN) that determines the type of object based on the image and determines an appropriate action for the vehicle 200.

As described above in relation to block 702, the LIDAR source 102 may continuously emit sequences of polarized interrogating light onto an object. Because the polarization of interrogating light is constantly changing, the LIDAR controller 106 can discriminate between polarized light that reflects off of a metal object in a scene and other light that may be present at a scene. For example, when the LIDAR source 102 switches from emitting 45° polarized NIR light to 135° polarized NIR light, the second pixel 604 should stop detecting reflected light and the third pixel 606 should start detecting reflected light. If the second pixel 604 stops detecting light after the LIDAR source 102 switches from emitting 45° polarized NIR light to 135° polarized NIR light, the LIDAR controller 106 may determine that light detected by the second pixel 604 is not light reflecting off of the object.

The LIDAR controller 106 may also determine a distance to an object based on the plurality of pixel signals. For example, the LIDAR controller 106 may determine the location of an object based on the specific two-by-two pixel subsets 600 of the pixel array 310 that detect light reflecting off of the object.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various implementations of the present invention. Numerous variations and modifications will become apparent to those skilled in the art once the above disclosure is fully appreciated. It is intended that the following claims be interpreted to embrace all such variations and modifications.

What is claimed is:

1. A light detection and ranging (LIDAR) sensor, comprising:
a pixel array including a first pixel, a second pixel, a third pixel, and a fourth pixel arranged in a two-by-two grid; and
a spectral router configured to:
route a first light with a first polarization to the first pixel,
route a second light with a second polarization to the second pixel, wherein the second polarization is about forty-five degrees greater than the first polarization,
route a third light with a third polarization to the third pixel, wherein the third polarization is orthogonal to the second polarization, and
route a fourth light with a fourth polarization to the fourth pixel, wherein the fourth polarization is orthogonal to the first polarization.

2. The LIDAR sensor of claim 1, further comprising a band-pass light filter positioned in front of the spectral router, the band-pass light filter configured to block light having wavelengths other than a predetermined wavelength.

3. The LIDAR sensor of claim 2, wherein the predetermined wavelength is between about 750 nanometers and 1,000 nanometers.

4. The LIDAR sensor of claim 2, further comprising an infrared spectral filter positioned in front of the band-pass light filter, the infrared spectral filter configured to block visible light.

5. The LIDAR sensor of claim 1, wherein each of the first pixel, the second pixel, the third pixel, and the fourth pixel includes a photosensitive region and one or more light scattering structures disposed within the photosensitive region.

6. The LIDAR sensor of claim 1, wherein the first polarization is about ninety degrees, wherein the second polarization is about forty-five degrees, wherein the third polarization is about one-hundred and thirty-five degrees, and wherein the fourth polarization is about zero degrees.

7. A light detection and ranging (LIDAR) system, comprising:
a LIDAR source configured to illuminate an object with:
a first interrogating light having a first polarization,
a second interrogating light having a second polarization,
a third interrogating light having a third polarization that is orthogonal to the second polarization, and
a fourth interrogating light having a fourth polarization that is orthogonal to the first polarization;
a LIDAR sensor including:
a pixel array including a plurality of pixel subsets, wherein each of the plurality of pixel subsets including:
four pixels configured to generate pixel signals, and
a spectral router configured to:
route a first reflected light having the first polarization to a first of the four pixels,
route a second reflected light having the second polarization to a second of the four pixels,
route a third reflected light having the third polarization to a third of the four pixels, and
route a fourth reflected light having the fourth polarization to a fourth of the four pixels; and
a LIDAR controller configured to determine whether the object is metal based on the pixel signals.

8. The LIDAR system of claim 7, wherein the LIDAR sensor further includes a band-pass light filter positioned in front of the spectral router, the band-pass light filter configured to block light having wavelengths other than a predetermined wavelength.

9. The LIDAR system of claim 8, wherein the predetermined wavelength is between about 750 nanometers and 1,000 nanometers.

10. The LIDAR system of claim 8, wherein the first interrogating light, the second interrogating light, the third interrogating light, and the fourth interrogating light having the predetermined wavelength.

11. The LIDAR system of claim 8, wherein the LIDAR sensor further includes an infrared spectral filter positioned in front of the band-pass light filter, the infrared spectral filter configured to block visible light.

12. The LIDAR system of claim 7, wherein the LIDAR source includes one or more near infrared (NIR) emitters.

13. The LIDAR system of claim 7, wherein each of the four pixels includes a photosensitive region and one or more light scattering structures disposed within the photosensitive region.

14. The LIDAR system of claim 7, wherein the first polarization is about ninety degrees, wherein the second polarization is about forty-five degrees, wherein the third polarization is about one-hundred and thirty-five degrees, and wherein the fourth polarization is about zero degrees.

15. The LIDAR system of claim 7, wherein the four pixels in each of the plurality of pixel subsets are arranged in a two-by-two grid.

16. A method for performing light detection and ranging (LIDAR), the method comprising:
illuminating an object with interrogating light having a first polarization, a second polarization that is about forty-five degrees greater than the first polarization, a third polarization that is orthogonal to the second polarization, and a fourth polarization that is orthogonal to the first polarization;
routing, with a spectral router, a first reflected light having the first polarization to a first set of pixels included in a pixel array;
routing, with the spectral router, a second reflected light having the second polarization to a second set of pixels included in the pixel array;
routing, with the spectral router, a third reflected light having the third polarization to a third set of pixels included in the pixel array;
routing, with the spectral router, a fourth reflected light having the fourth polarization to a fourth set of pixels included in the pixel array;
generating a plurality of pixel signals with the pixel array; and
determining whether the object is metal based on the plurality of pixel signals.

17. The method of claim 16, wherein the interrogating light includes near infrared (NIR) light.

18. The method of claim 17, further comprising:
blocking, with an infrared spectral filter, visible light from entering the spectral router.

19. The method of claim 16, wherein the first polarization is about ninety degrees, wherein the second polarization is about forty-five degrees, wherein the third polarization is about one-hundred and thirty-five degrees, and wherein the fourth polarization is about zero degrees.

20. The method of claim 16, further comprising:
determining a distance to the object based on the plurality of pixel signals.
